(19) United States
(12) Patent Application Publication
(10) Pub. No.: US 2016/0062449 A1
(43) Pub. Date: Mar. 3, 2016

(54) COMPUTING PLATFORM POWER CONSUMPTION LEVEL ADJUSTMENT

(71) Applicant: Hewlett-Packard Development Company, L.P., Fort Collins, CO (US)

(72) Inventors: Peter Hansen, Cypress, TX (US); Julie Victoria Tan, Houston, TX (US); Sivathevan Maheswaran, Houston, TX (US)

(21) Appl. No.: 14/470,837

(22) Filed: Aug. 27, 2014

(51) Int. Cl. G06F 1/32; G06F 1/30

(52) U.S. Cl. CPC G06F 1/3296; G06F 1/3206; G06F 1/305

(57) ABSTRACT

Example implementations relate to power consumption level adjustment of a computing device. For example, an implementation includes a computing cell and a power subsystem housed in a chassis. A power manager of the power subsystem is to assert an emergency brake signal to a power controller to the computing cell in response to a detection of a power output reduction, to transmit power consumption information to the power controller, and to assert a power restore signal to the power controller. The power controller is to transition a power consumption level of the computing cell from a first level to a second level based on the emergency brake signal, to transition the power consumption level from the second level to a third level based on the power consumption information, and to transition the power consumption level from the third level to the first level based on the power restore signal.

### BACKGROUND

To increase computing resource density in a datacenter, multiple computing devices, such as server computers, may be mounted to a rack. The rack may provide electrical power to the multiple computing devices.

### BRIEF DESCRIPTION OF THE DRAWINGS

Some examples of the present application are described with respect to the following figures:

FIG. 1 is a block diagram of a computing platform to adjust a power consumption level of a computing cell of the computing platform, according to an example;

FIG. 2 is a block diagram of a computing platform to adjust a power consumption level of a computing cell of the computing platform, according to an example;

FIG. 3 is a diagram to illustrate power consumption level adjustments of a computing cell, according to an example;

FIG. 4 is a block diagram of a power manager of a power subsystem of a computing platform, according to an example;

FIG. 5 is a block diagram of a power manager of a power subsystem of a computing platform, according to an example;

FIG. 6 is a block diagram of a power controller of a computing cell of a computing platform, according to an example;

FIG. 7 is a flowchart illustrating a method of adjusting a power consumption level of a computing cell at a power manager of a power subsystem of a computing platform, according to an example; and

FIG. 8 is a flowchart illustrating a method of adjusting a power consumption level of a computing cell at a power controller of the computing cell, according to an example.

### DETAILED DESCRIPTION

As described above, a rack that houses multiple computing devices may provide electrical power to the multiple computing devices. For example, a rack may include a power subsystem to convert alternating current (AC) power to direct current (DC) power and supply the DC power to multiple computing devices housed in the rack. The power subsystem may include at least one rectifier. However, when power subsystem experiences a power output reduction, such as due to a rectifier failure, the multiple computing devices may be unexpectedly shut down due to insufficient power supply if the power output reduction is not remediated in a timely manner (e.g., less than seven milliseconds). Thus, available computing resources at the rack are reduced.

Examples described herein provide a computing platform that may adjust power consumption level of a computing cell in response to a power output reduction of a power subsystem. For example, a computing platform may include at least one computing cell housed in a chassis. The computing cell may include a plurality of computing devices, such as server computers. The computing platform may also include a power subsystem housed in the chassis. The power subsystem may supply DC power to the computing cell via at least one rectifier.

In response to detecting a power output reduction, the power subsystem may assert an emergency brake signal to the computing cell. The computing cell may reduce power consumption from a first level to a second level. The power subsystem may transmit power consumption information to the computing cell while the power consumption level of the computing cell is at the second level. In response to the power consumption information, the computing cell may increase the power consumption to a third level. When the power output reduction is remediated, the power subsystem may assert a power restore signal to the computing cell, the computing cell may increase the power consumption from the third level to the first level. In this manner, examples described herein may reduce a likelihood of losing computing resources due to a power output reduction of a power subsystem.

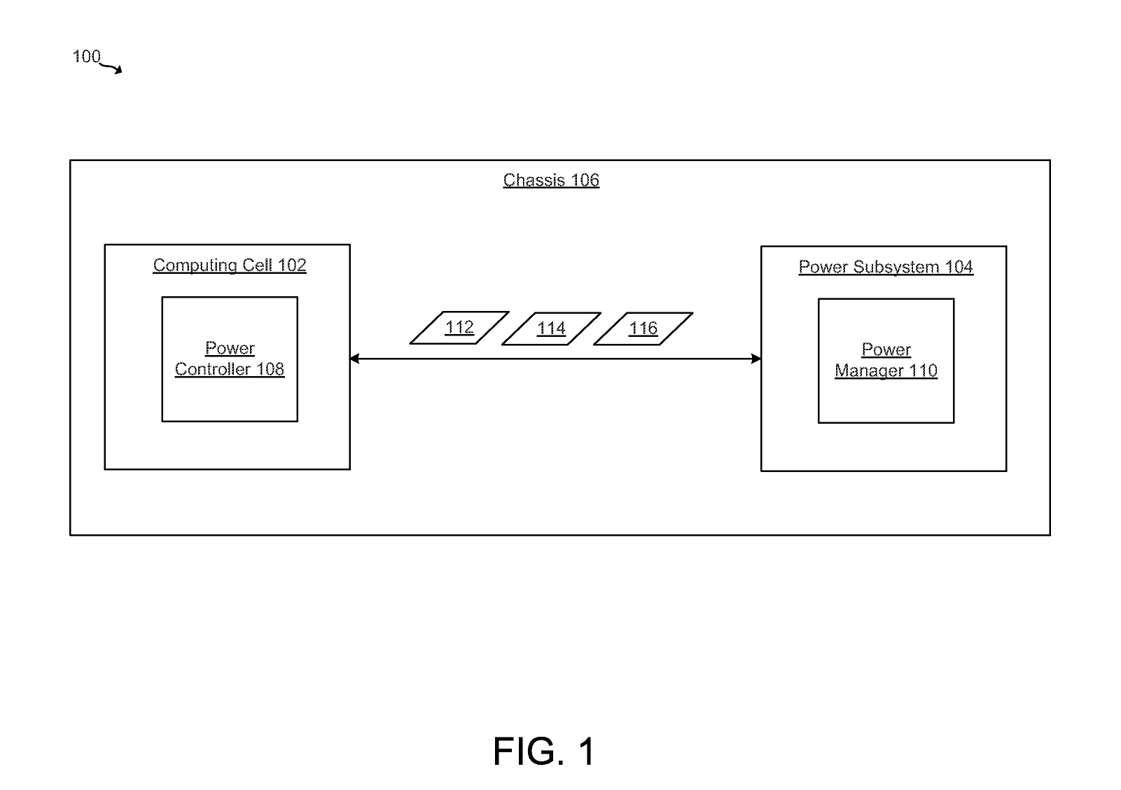

Referring now to the figures, FIG. 1 is a block diagram of a computing platform 100 to adjust a power consumption level of a computing cell of the computing platform, according to an example. Computing platform 100, for example, may be a computing system or architecture that includes a plurality of interconnected computing devices to provide scalability based on processing capability demands. As an example, computing platform 100 may be a server computer that includes a plurality of processors and/or server computers interconnected via a switching fabric. Computing platform 100 may include a computing cell 102 and a power subsystem 104. In some examples, computing cell 102 and power subsystem 104 may be housed in a chassis 106. Chassis 106 may be a rack, an enclosure, or a cabinet for mounting computing devices, such as one rack unit (1 U) server computers.

Computing cell 102 may be a set of computing devices. For example, computing cell 102 may be a server. As another example, computing cell may include a plurality of server computers computer interconnected via a switching fabric. Computing cell 102 may include a power controller 108 to control power consumption of computing cell 102. In some examples, power controller 108 may be a semiconductor-based microprocessor and/or other hardware devices suitable to control power consumption of a computing device. In some examples, power controller 108 may control power consumption of computing cell 102 by throttling a central processing unit (CPU) of computing cell 102. In some examples, power controller 108 may control power consumption of computing cell 102 by putting a percentage of graphics processing units (CPUs) into lower power states.

Power subsystem 104 may be a power shelf to provide DC power to computing cell 102. In some examples, power subsystem 104 may provide the DC power using at least one rectifier. Power subsystem 104 may be a non-redundant power subsystem of computing platform 100. As used herein, “non-redundant power subsystem” may mean that computing platform 100 includes a single power subsystem and does not include a backup power subsystem. Power subsystem 104 may include a power manager 110 to monitor power output capability of power subsystem 104 and power status of computing cell 102. In some examples, power manager 110 may be a semiconductor-based microprocessor and/or other hardware devices suitable to monitor power output capacity of a power subsystem and workload of a computing cell. Power manager 110 may be hardwired to rectifier(s) in power subsystem 104 and to computing cell 102. In some examples, power manager 110 may track workload in computing cell 102 and map power output of power subsystem 104 based on the workload.

During operation, when power manager 110 detects a power output reduction at power subsystem 104, power manager 110 may assert an emergency brake signal 112 to computing cell 102. In response to detecting emergency brake signal 112, computing cell 102 may transition from a normal operation mode to a first power saving mode via power controller 108. The normal operation mode may be associated with a first power consumption level of computing cell 102. The first power consumption level may be an amount of power computing cell 102 may consume under a full load, such as when the CPU and/or CUP of computing cell 102 is at 100% usage. The first power saving mode may be associated with a second power consumption level. The second power consumption level may define a first power consumption threshold of computing cell 102. The first power consumption threshold may be an upper power consumption threshold. That is, power consumption of computing cell 102 may be capped by the first power consumption threshold.

The second power consumption level may be pre-defined such that the second power consumption level may be independent of the power output capacity of power subsystem 206 when the power output reduction is detected. That is, the second power consumption level may not be tied to or based on the power output capacity of power subsystem 206 when the power output reduction is detected. As an example, the second power consumption level may be an amount of power that the computing cell 102 consumes to operate. When there is less power supplied to computing cell 102 than the second power consumption level, computing cell 102 may not receive enough power to stay powered on.

Subsequent to asserting emergency brake signal 112, power manager 110 may transmit power consumption information 114 to power controller 108. In some examples, power consumption information 114 may correspond to a third power consumption level of computing cell 102 as determined by power manager 110. Power manager 110 may determine the third power consumption level based on the power output capacity of power subsystem 104 during the power output reduction. The third power consumption level may define a second upper power consumption threshold. In some examples, power consumption information 114 may correspond to power output capacity information of power subsystem 104 during the power output reduction and power controller 108 may determine the second power consumption threshold using the power output capacity information. The second power consumption threshold may be an upper power consumption threshold. In some examples, power consumption information 114 may correspond to the second power consumption threshold that is determined by power manager 110.

Based on the power consumption information 114, computing cell 102 may transition from the first power saving mode to a second power saving mode associated with the second power consumption threshold. The third power consumption level defining the second power consumption threshold may be greater than the second power consumption level but less than the first power consumption level.

When power manager 110 detects a remediation of the power output reduction at power subsystem 104, power manager 110 may assert a power restore signal 116 to power controller 108. In response to detecting power restore signal 116, power controller 108 may transition computing cell 102 from the second power saving mode back to the normal operation mode. Thus, power controller 108 may increase the power consumption of computing cell 102 from the third power consumption level back to the first power consumption level. Thus, power controller 108 may adjust the power consumption level of computing cell 102 based on the power output capacity of power subsystem 104 to reduce a likelihood of computing cell 102 unexpectedly shutting down due to a power output reduction at power subsystem 104.

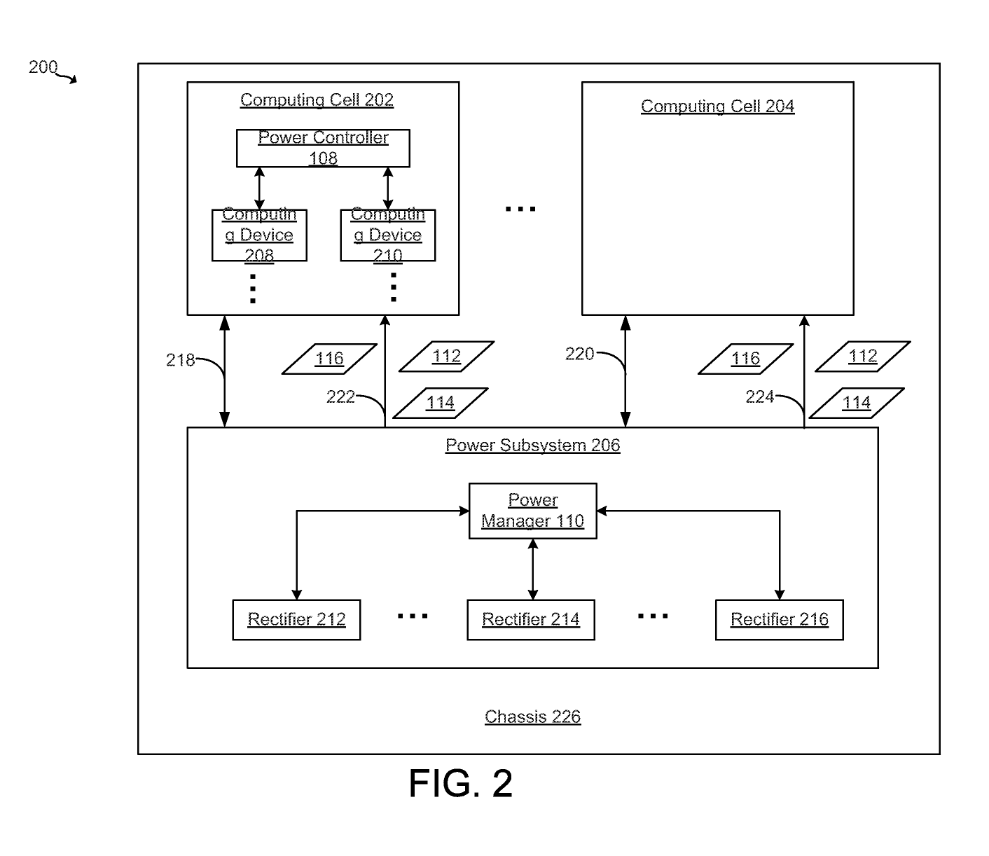

FIG. 2 is a block diagram of a computing platform 200 to adjust a power consumption level of a computing cell of the computing platform, according to an example. Computing platform 200 may be similar to computing platform 100 of FIG. 1. Computing platform 200 may include a plurality of computing cells, such as computing cells 202 and 204. Computing cell 202 may include power controller 108 and a plurality of computing devices, such as computing devices 208 and 210. Computing devices 208 and 210 may be server computers, Computing devices 208 and 210 may be connected to power controller 108. Computing cell 204 may be similar to computing cell 202. Although two computing cells are shown in FIG. 2, it should be understood that computing platform 200 may include any number of computing cells. Each computing cell may include any number of computing devices.

Computing platform 200 may also include a single power subsystem 206 similar to power subsystem 104. Power subsystem 206 may provide DC power to computing cells 202-204. Power subsystem 206 may include power manager 110 and a plurality of rectifiers, such as rectifiers 212-216. Rectifiers 212-216 may convert AC power to DC power that is used by computing cells 202-204. Power manager 110 may be connected to rectifiers 212-216. Power subsystem 206 may provide the DC power to computing cells 202 and 204 via connections 218 and 222, respectively. Power manager 110 may adjust power consumption levels of computing cells 202 and 204 via connections 222 and 224, respectively. Computing cells 202-204 and power subsystem 206 may be housed in a chassis 226.

For purpose of brevity, operations of computing cells of computing platform 200 are described with reference to computing cell 202. Operations of computing cell 204 may be similar to operations of computing cell 202.

During operation, when power manager 110 detects a power output reduction of power subsystem 206, power manager 110 may assert emergency brake signal 112 to computing cell 202 via connection 222. The power output reduction may correspond to a failure (e.g., malfunctioning) of one of rectifiers 212-216, a removal of AC feed to one of rectifiers 212-216, or a loss of AC feed to one of rectifiers 212-216. Power manager 110 may assert emergency brake signal 112 in a first format that has a low latency so that computing cell 202 may receive emergency brake signal 112 quickly. For example, connection 222 may correspond to a serial cable and power manager 110 may assert emergency brake signal 112 by setting pin 1 of the serial cable to an active state by applying a particular amount of voltage to pin 1.

Based on emergency brake signal 112, computing cell 202 may transition from the normal operation mode to the first power saving mode via power controller 108, While computing cell 202 is operating in the first power saving mode, power manager 110 may transmit power consumption information 114 to computing cell 202. Power manager 110 may transmit power consumption information 114 in a second format that has a higher latency than the first format. As an example, power manager 110 may transmit power consumption information 114 as a packet via connection 222.

Based on power consumption information 114, computing cell 202 may transition from the first power saving mode to the second power saving mode via power controller 108. When power manager 110 detects a remediation of the power output reduction, power manager 110 may assert power restore signal 116 to computing cell 202. Based on power restore signal 116, computing cell 202 may transition from the second power saving mode back to the normal operation mode.

Power manager 110 may assert power restore signal 116 in the first format. In some examples, emergency brake signal 112 and power restore signal 116 may correspond to different states of the same signal. As an example, emergency brake signal 112 may correspond to an active state of a pin of a cable. Power restore signal 116 may correspond to an inactive state of the pin. In some examples, emergency brake signal 112 and power restore signal 116 may be different signals. As an example, emergency brake signal 112 may correspond to a signal asserted via pin 1 of a cable while power restore signal 116 may correspond to a signal asserted via pin 2 of the cable.

Thus, when power subsystem 206 detects a power output reduction, computing cell 202 may reduce power consumption to stay powered on so that computing resources of computing platform 200 are not lost. When the reduced power output capacity of power subsystem 206 is determined, computing cell 202 may increase the power consumption based on the reduced power output capacity to not overwhelm power subsystem 206 and to increase the computing resources. When the power output reduction is remediated, computing cell 202 may increase the power consumption back to a level prior to the power output reduction.

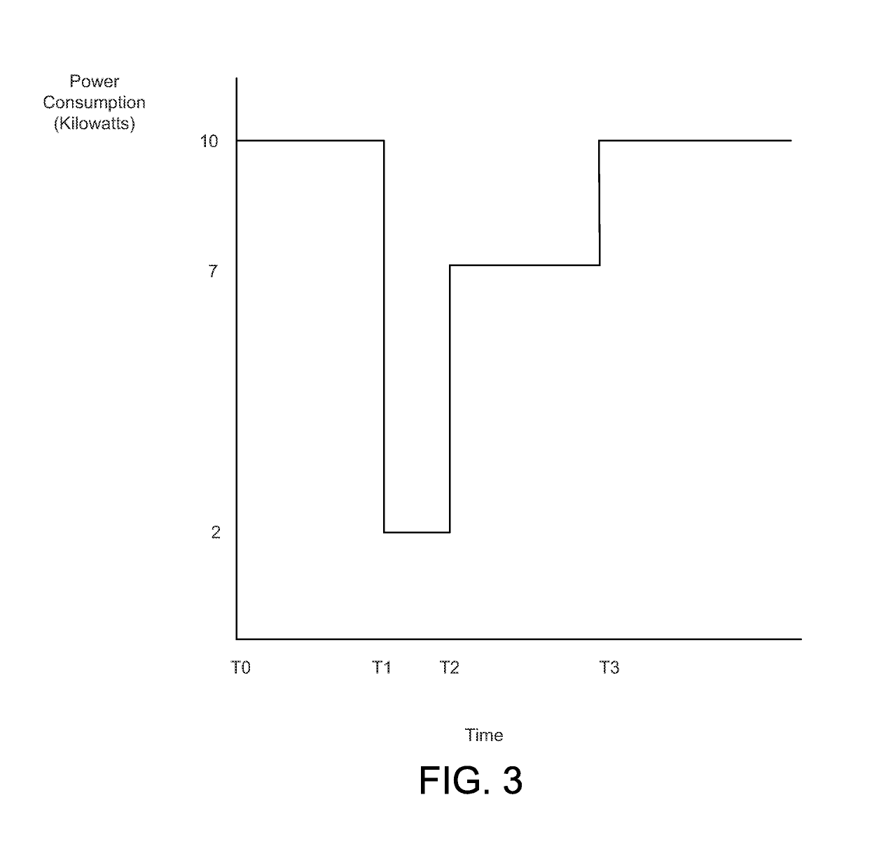

FIG. 3 is a diagram to illustrate power consumption level adjustments of a computing cell, such as computing cell 102 of FIG. 1 and/or computing cells 202-204 of FIG. 2, according to an example. Prior to time T1, the computing cell may have a power consumption of 10 Kilowatts (kW). The 10 kW may be the first power consumption level. At time T1, the computing cell may detect an emergency brake signal, such as emergency brake signal 112. Based on the emergency brake signal, the computing cell may reduce power consumption from 10 kW to 2 kW. The 2 kW may be the second power consumption level. At time T2, based on power consumption information, such as power consumption information 114, the computing cell may increase power consumption from 2 kW to 7 kW. The 7 kW may be the third power consumption level. At time T3, based on a power restore signal, such as power restore signal 116, the computing cell may increase power consumption from 7 kW back to 10 kW.

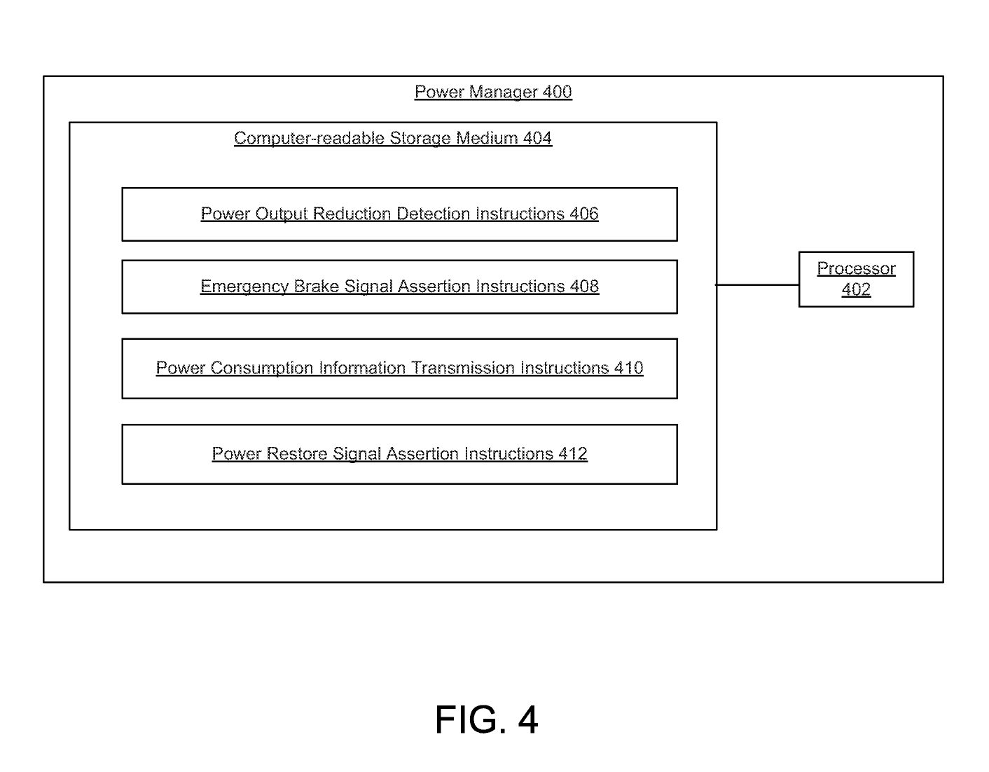

FIG. 4 is a block diagram of a power manager 400 of a power subsystem of a computing platform, according to an example. Power manager 400 may implement power manager 110 of FIGS. 1 and 2. Power manager 400 may include a processor 402 and a computer-readable storage medium 404.

Processor 402 may be a central processing unit (CPU), a semiconductor-based microprocessor, and/or other hardware devices suitable for retrieval and execution of instructions stored in computer-readable storage medium 404. Processor 402 may fetch, decode, and execute instructions 406-412 to control a process of adjusting power consumption levels of a computing cell. As an alternative or in addition to retrieving and executing instructions, processor 402 may include at least one electronic circuit that includes electronic components for performing the functionality of instructions 406, 408, 410, 412, or a combination thereof.

Computer-readable storage medium 404 may be any electronic, magnetic, optical, or other physical storage device that contains or stores executable instructions. Thus, computer-readable storage medium 404 may be, for example, Random Access Memory (RAM), an Electrically Erasable Programmable Read-Only Memory (EEPROM), a storage device, an optical disc, etc. In some examples, computer-readable storage medium 404 may be a non-transitory storage medium, where the term “non-transitory” does not encompass transitory propagating signals. As described in detail below, computer-readable storage medium 404 may be encoded with a series of processor executable instructions 406-412 for adjusting power consumption levels of a computing cell.

Power output reduction detection instructions 406 may detect a power output reduction of a power subsystem, such as power subsystem 104 of FIG. 1 or power subsystem 206 of FIG. 2. Emergency brake signal assertion instructions 408 may assert an emergency brake signal, such as emergency brake signal 112, to a computing cell, such as computing cell 102, 202, or 204, based on the power output reduction.

Power consumption information transmission instructions 410 may transmit power consumption information, such as power consumption information 114, to the computing cell. Power restore signal assertion instructions 412 may assert a power restore signal, such as power restore signal 116, to the computing cell based on a remediation of the power output reduction.

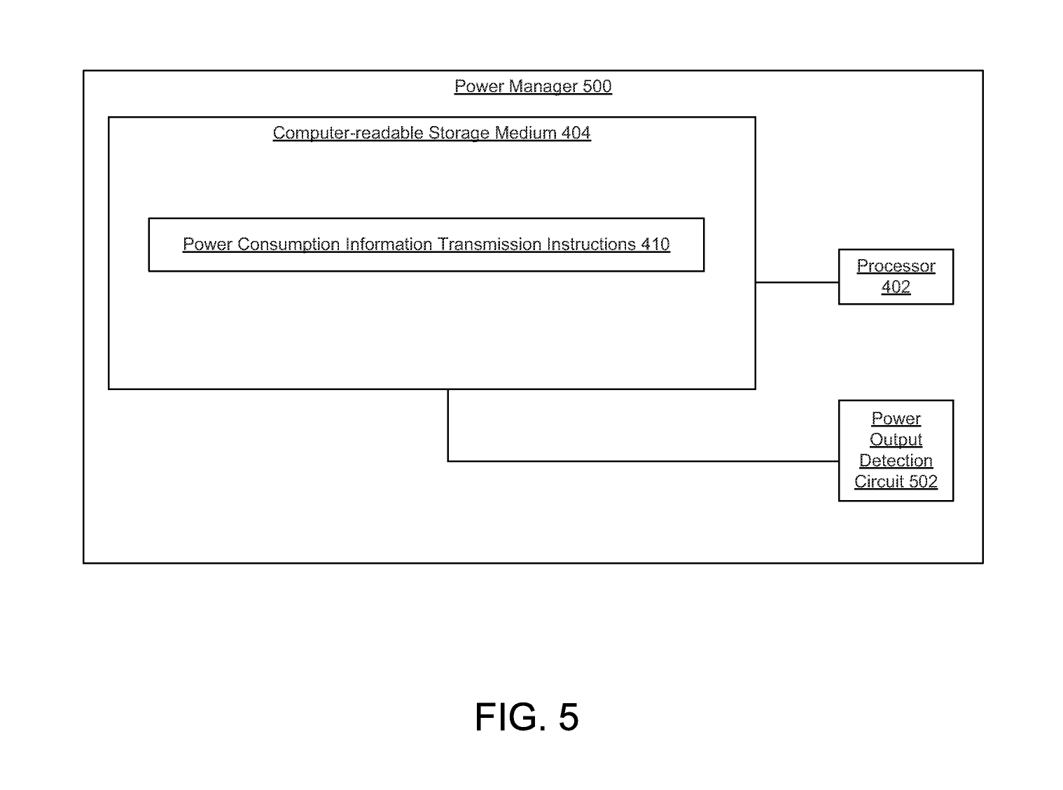

FIG. 5 is a block diagram of a power manager 500 of a power subsystem of a computing platform, according to an example. Power manager 500 may implement power manager of FIGS. 1 and 2. Power manager 500 may include processor 402, computer-readable storage medium 404, and a power output detection circuit 502. Computer-readable storage medium 404 may be encoded with processor executable instructions 504 for adjusting power consumption levels of a computing cell.

Power output detection circuit 502 may be a circuit or circuitry that detects changes in power output of a power subsystem, such as power subsystem 104 of FIG. 1 or power subsystem 206 of FIG. 2. When power output detection circuit 502 detects a power output reduction (e.g., due to a rectifier failure), power output detection circuit 502 may assert the emergency brake signal, such as emergency brake signal 112, to a computing cell, such as computing cell 102, 202, or 204. When power output detection circuit 502 detects a remediation of the power output reduction, power output detection circuit 502 may assert a power restore signal, such as power restore signal 116, to the computing cell. Power consumption information transmission instructions 410 may transmit power consumption information, such as power consumption information 114, to the computing cell after the emergency brake signal is asserted.

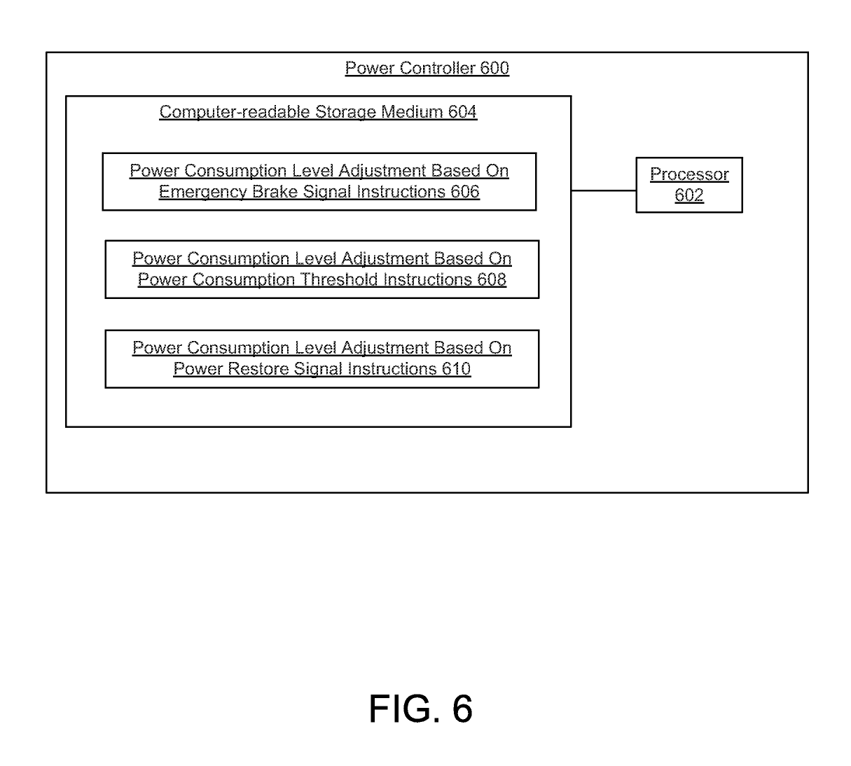

FIG. 6 is a block diagram of a power controller 600 of a computing cell of a computing platform, according to an example. Power controller 600 may implement power controller 108 of FIGS. 1 and 2. Power controller 600 may include a processor 602 and a computer-readable storage medium 604. Processor 602 may be similar to processor 402 of FIG. 4. Computer-readable storage medium 604 may be similar to computer-readable storage medium 404.

Computer-readable storage medium 604 may be encoded with a series of processor executable instructions 606-610 to adjust power consumption levels of a computing cell, such as computing cell 102, 202, or 204.

Power consumption level adjustment based on emergency brake signal instructions 606 may reduce power consumption of the computing cell from a first power consumption level to a second power consumption level based on an emergency brake signal, such as emergency brake signal 112. Power consumption level adjustment based on power consumption threshold instructions 608 may increase the power consumption of the computing cell from the second power consumption level to a third power consumption level that is less than the first power consumption level based on a power consumption threshold, such as power consumption information 114.

Power consumption level adjustment based on power restore signal instructions 610 may increase the power consumption level of the computing cell from the third power consumption level back to the first power consumption level based on a power restore signal, such as power restore signal 116.

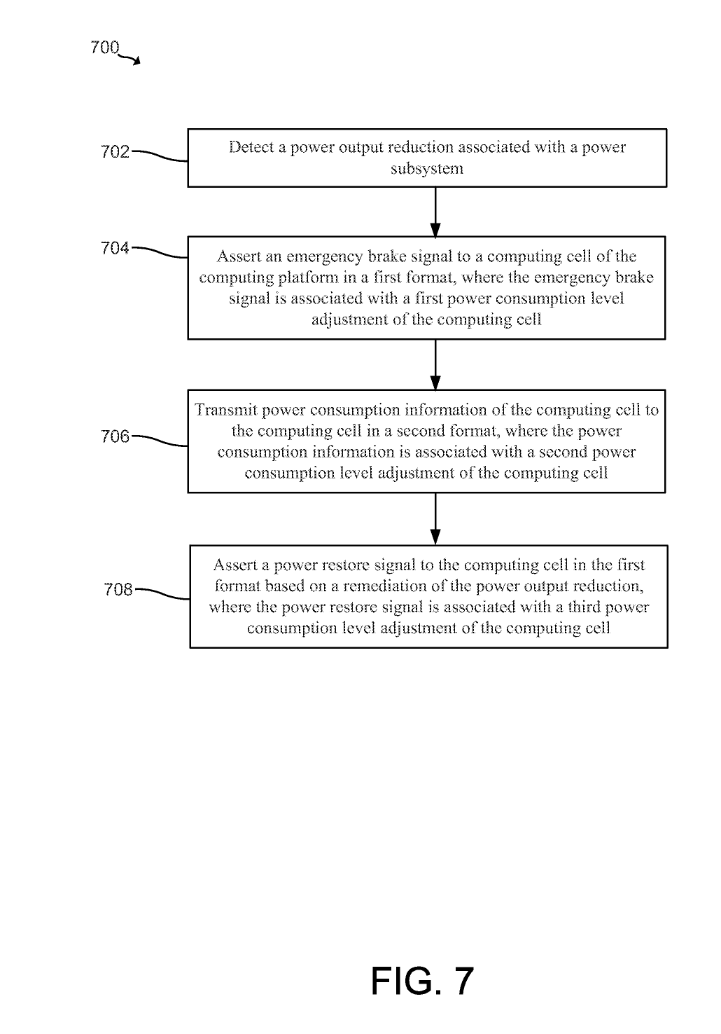

FIG. 7 is a flowchart illustrating a method 700 of adjusting a power consumption level of a computing cell at a power manager of a power subsystem of a computing platform, according to an example. Method 700 may be implemented using power manager 110 of FIGS. 1 and 2, power manager 400 of FIG. 4, or power manager 500 of FIG. 5. Method 700 includes detecting a power output reduction associated with a power subsystem, at 702. For example, referring to FIG. 2, power manager 110 may detect a power output reduction of power subsystem 206. Method 700 also includes asserting an emergency brake signal to a computing cell of the computing platform in a first format, where the emergency brake signal is associated with a first power consumption level adjustment of the computing cell, at 704. For example, referring to FIG. 2, when power manager 110 detects a power output reduction of power subsystem 206, power manager 110 may assert emergency brake signal 112 to computing cell 202 via connection 222.

Method 700 further includes transmitting power consumption information of the computing cell to the computing cell in a second format, where the power consumption information is associated with a second power consumption level adjustment of the computing cell, at 706. For example, referring to FIG. 2, power manager 110 may transmit power consumption information 114 to computing cell 202. Method 700 further includes asserting a power restore signal to the computing cell in the first format based on a remediation of the power output reduction, where the power restore signal is associated with a third power consumption level adjustment of the computing cell, at 708. For example, referring to FIG. 2, power manager 110 may assert power restore signal 116 to computing cell 202.

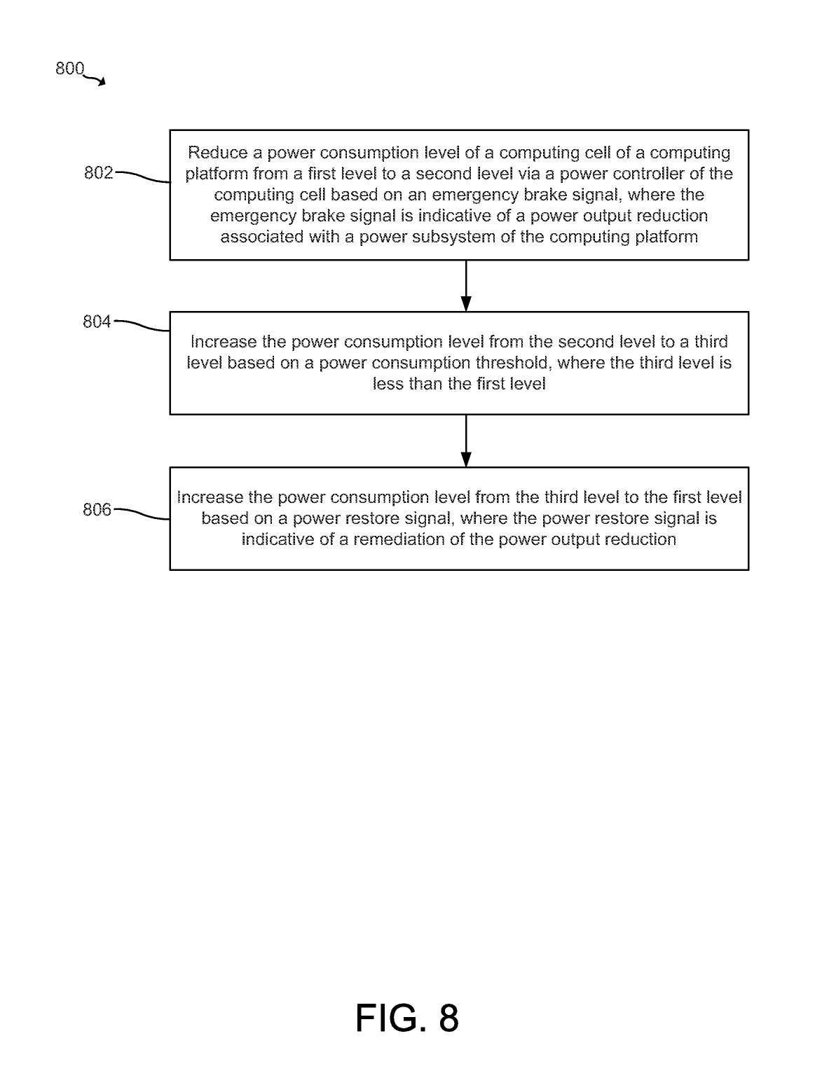

FIG. 8 is a flowchart illustrating a method 800 of adjusting a power consumption level of a computing cell at a power controller of the computing cell, according to an example. Method 800 may be implemented using power controller 108 of FIGS. 1-2 or power controller 600 of FIG. 6. Method 800 includes reducing a power consumption level of a computing cell of a computing platform from a first level to a second level via a power controller of the computing cell based on an emergency brake signal, where the emergency brake signal is indicative of a power output reduction associated with a power subsystem of the computing platform, at 802. For example, referring to FIG. 2, based on emergency brake signal 112, computing cell 202 may transition from the normal operation mode to the first power saving mode via power controller 108.

Method 800 also includes increasing the power consumption level from the second level to a third level based on a power consumption threshold, where the third level is less than the first level, at 804. For example, referring to FIG. 2, based on power consumption information 114, computing cell 202 may transition from the first power saving mode to the second power saving mode via power controller 108.

Method 800 further includes increasing the power consumption level from the third level to the first level based on a power restore signal, where the power restore signal is indicative of a remediation of the power output reduction, at 806. For example, referring to FIG. 2, when power manager 110 detects a remediation of the power output reduction, power manager 110 may assert power restore signal 116 to computing cell 202. Based on power restore signal 116, computing cell 202 may transition from the second power saving mode back to the normal operation mode.

According to the foregoing, examples disclosed herein enable a computing cell to adjust a power consumption level based on a power output capacity of a power subsystem. The computing cell may reduce power consumption from a first level to a second level based on an emergency brake signal asserted by a power manager of the power subsystem. The emergency brake signal may be indicative of a power output reduction of the power subsystem. The computing cell may increase the power consumption from the second level to a third level based on power consumption information received from the power manager. The power consumption information may be indicative of a power output capacity of the power subsystem. The computing cell may increase the power consumption from the third level back to the first level based on a power restore signal asserted by the power manager. The power restore signal may be indicative of a remediation of the power output reduction. Thus, the computing cell may stay powered on when the power subsystem has a reduced power output capacity.

The use of “comprising”, “including” or “having” are synonymous and variations thereof herein are meant to be inclusive or open-ended and do not exclude additional unrecited elements or method steps.

What is claimed is:

1. An apparatus comprising:
a chassis;
a computing cell housed in the chassis, wherein the computing cell includes a power controller; and
a power subsystem housed in the chassis to provide electrical power to the computing cell, wherein the power subsystem includes a power manager,
wherein the power manager is to:
in response to a detection of a power output reduction associated with the power subsystem, assert an emergency brake signal to the computing cell;
determine, while the computing cell is in a first power saving mode, a power consumption threshold of the computing cell; and
transmit the power consumption threshold to the computing cell, and
wherein the power controller is to:
transition the computing cell from a normal operation mode to the first power saving mode based on the emergency brake signal; and
transition the computing cell from the first power saving mode to a second power saving mode based on the power consumption threshold.

2. The apparatus of claim 1, wherein the power manager is further to, assert a power restore signal to the computing cell based on a remediation of the power output reduction, and wherein the power controller is further to, transition the computing cell from the second power saving mode to the normal operation mode based on the power restore signal.

3. The apparatus of claim 1, wherein the computing cell has a first power consumption level during the normal operation mode, wherein the computing cell has a second power consumption level during the first power saving mode, and wherein the second power consumption level is less than the first power consumption level.

4. The apparatus of claim 3, wherein computing cell has a third power consumption level during the second power saving mode, wherein the third power consumption level is less than the first power consumption, and wherein the third power consumption level is greater than the second power consumption level.

5. The apparatus of claim 1, wherein the computing cell includes a plurality of computing devices, wherein the power subsystem includes a plurality of rectifiers, and wherein the power output reduction corresponds to a failure of one of the plurality of rectifiers, a loss of alternating current (AC) feed to one of the plurality of rectifiers, or a removal of AC feed to one of the plurality of rectifiers.

6. The apparatus of claim 1, wherein the power subsystem is a non-redundant power subsystem, wherein the power manager is to assert the emergency brake signal in a first format via a connection to the computing cell, wherein the power manager is to transmit the power consumption threshold in a second format via the connection, and wherein the second format has a higher latency than the first format.

7. The apparatus of claim 1, wherein the power consumption threshold corresponds to an upper power consumption threshold of the computing cell.

8. A method comprising:
reducing a power consumption level of a computing cell of a computing platform from a first level to a second level via a power controller of the computing cell based on an emergency brake signal, wherein the emergency brake signal is indicative of a power output reduction associated with a power subsystem of the computing platform;
increasing the power consumption level from the second level to a third level based on a power consumption threshold, wherein the third level is less than the first level; and
increasing the power consumption level from the third level to the first level based on a power restore signal, wherein the power restore signal is indicative of a remediation of the power output reduction.

9. The method of claim 8, further comprising:
via a power manager of the power subsystem:
detecting the power output reduction;
asserting the emergency brake signal to the computing cell;
subsequent to asserting the emergency brake signal, determining the power consumption threshold based on power output capacity information of the power subsystem; and
transmitting the power consumption threshold to the computing cell as a packet.

10. The method of claim 8, further comprising:
via a power manager of the power subsystem:
detecting the power output reduction;
asserting the emergency brake signal to the computing cell; and
subsequent to asserting the emergency brake signal, transmitting power output capacity information of the power subsystem to the computing cell; and
via the power controller:
determining the power consumption threshold based on the power output capacity information.

11. The method of claim 10, wherein the power subsystem is a non-redundant power subsystem of the computing platform, wherein the emergency brake signal is asserted in a first format, wherein the power output capacity information is transmitted in a second format, and wherein the second format has a higher latency than the first format.

12. A computer-readable storage medium comprising instructions that when executed cause a controller of a power subsystem of a computing platform to:
detect a power output reduction associated with the power subsystem;
assert an emergency brake signal to a computing cell of the computing platform in a first format, wherein the emergency brake signal is associated with a first power consumption level adjustment of the computing cell;
transmit power consumption information of the computing cell to the computing cell in a second format, wherein the power consumption information is associated with a second power consumption level adjustment of the computing cell, and wherein the first format has a lower latency than the second format; and
assert a power restore signal to the computing cell in the first format based on a remediation of the power output reduction, wherein the power restore signal is associated with a third power consumption level adjustment of the computing cell.

13. The computer-readable storage medium of claim 12, wherein the first power consumption level adjustment is a power consumption level reduction of the computing cell, wherein the second power consumption level adjustment is a first power consumption level increase of the computing cell, and wherein the third power consumption level adjustment is a second power consumption level increase of the computing cell.

14. The computer-readable storage medium of claim 12, wherein the power consumption information includes a power consumption threshold of the computing cell.

15. The computer-readable storage medium of claim 12, wherein the power consumption information includes power output capacity information of the power subsystem.
